(19) United States
(12) Patent Application Publication
(10) Pub. No.: US 2020/0380642 A1
(43) Pub. Date: Dec. 3, 2020

(54) MEDIA ALTERATION BASED ON ROTATION OF A PORTABLE COMPUTING DEVICE

(71) Applicant: PopSockets LLC, Boulder, CO (US)

(72) Inventors: Altan Nahum, Boulder, CO (US); David B. Barnett, Boulder, CO (US); Randy Yang Chiang, Boulder, CO (US)

(21) Appl. No.: 16/923,466

(22) Filed: Jul. 8, 2020

Related U.S. Application Data
(63) Continuation of application No. PCT/US2018/066680, filed on Dec. 18, 2018.
(60) Provisional application No. 62/614,959, filed on Jan. 8, 2018.

(51) Int. Cl. G06T 5/00; G06T 11/60; G06F 3/0346

(52) U.S. Cl. CPC G06T 5/002; G06F 3/0346; G06T 11/60

(57) ABSTRACT

Portable computing devices, software operating on such devices, and methods are described herein that utilize rotational data of the device to alter or distort media, such as images, gifs, and/or video, operating on the device. More specifically, when operating the software, an accelerometer within the device can determine when a user rotates or spins the device and thereafter a processing device can alter the media. Rotational characteristics, such as spin direction, spin speed, spin rate of change, and the like, can further factor into the modifications to the media.

### CROSS-REFERENCE TO RELATED APPLICATIONS

Priority is claimed to US Provisional Patent Application No. 62/614,959, filed Jan. 8, 2018, the entire contents of which are hereby incorporated herein by reference.

### FIELD OF THE DISCLOSURE

The present disclosure generally relates to software applications on a portable client device that implement an accelerometer to receive user inputs.

### BACKGROUND

Many portable devices (e.g., tablets, smart phones) are equipped with an accelerometer that can detect an angular velocity and/or changes to the angular velocity of the device. The accelerometer may be implemented in a variety of applications including orienting the device during GPS navigation, adjusting the screen display based on the orientation of the device, and manipulating controls in games (e.g., steering a car in a racing game).

### SUMMARY

A computer-implemented method for altering media based on a rotation event of a client device is described herein that includes receiving an image, gif, or video, receiving a selection of a distortion effect, measuring rotation of the client device with an accelerometer of the client device, and applying the distortion effect to the image, gif, or video based on the rotation of the client device.

In embodiments, applying the distortion effect can include one or more of: applying a spiral distortion effect to the image, gif, or video, applying a kaleidoscope effect to the image, gif, or video, applying a pixilation effect to the image, gif, or video, or generally any other conceivable distortion effect that may be desired.

In embodiments, the computer-implemented method can include saving a modified image, gif, or video that includes the distortion effect. In further embodiments, the modified image, gif, or video can transition between the image, gif, or video and the image, gif, or video with the distortion effect. In further embodiments, the computer-implemented method can include encoding the modified image, gif, or video.

In embodiments, the computer-implemented method can include inserting alphanumeric and/or graphical content on the image, gif, or video, either before or after the distortion effect.

A portable computing device is described herein that includes an accelerometer configured to determine rotation of the portable computing device and a processing device coupled to the accelerometer. The processing device is configured to receive an image, gif, or video, receive a selection of a distortion effect, measure rotation of the client device with an accelerometer of the client device, and apply the distortion effect to the image, gif, or video based on the rotation of the client device.

In embodiments, the processing device configured to apply the distortion effect can include one or more of: applying a spiral distortion effect to the image, gif, or video, applying a kaleidoscope effect to the image, gif, or video, and applying a pixilation effect to the image, gif, or video.

In embodiments, the processing device can be configured to save a modified image, gif, or video that includes the distortion effect. In further embodiments, the modified image, gif, or video can transition between the image, gif, or video and the image, gif, or video with the distortion effect. In further embodiments, the processing device can be configured to encode the modified image, gif, or video.

In embodiments, the processing device can be configured to insert alphanumeric content or graphical content on the image, gif, or video.

In embodiments, the portable computing device can include an expandable/collapsible grip accessory affixed to a back portion of the portable computing device by a securing element, wherein the expandable/collapsible grip accessory includes a rotating portion that is capable of allowing the portable computing device to rotate around an axis while another portion of the expandable/collapsible grip accessory remains still. In further embodiments, the expandable/collapsible grip accessory can include an cover forming a tapered shape connected to the securing element, the cover capable of extending outward generally along its axis from the portable media player and retracting back toward the portable computing device by collapsing generally along its axis and a foot disposed at the distal end of the cover. In further embodiments, the cover of the grip accessory can include rigid walls interspersed with flexural hinges.

### BRIEF DESCRIPTION OF THE DRAWINCIS

The above needs are at least partially met through provision of the computer-implemented method and portable computing device described in the following detailed description, particularly when studied in conjunction with the drawings, wherein:

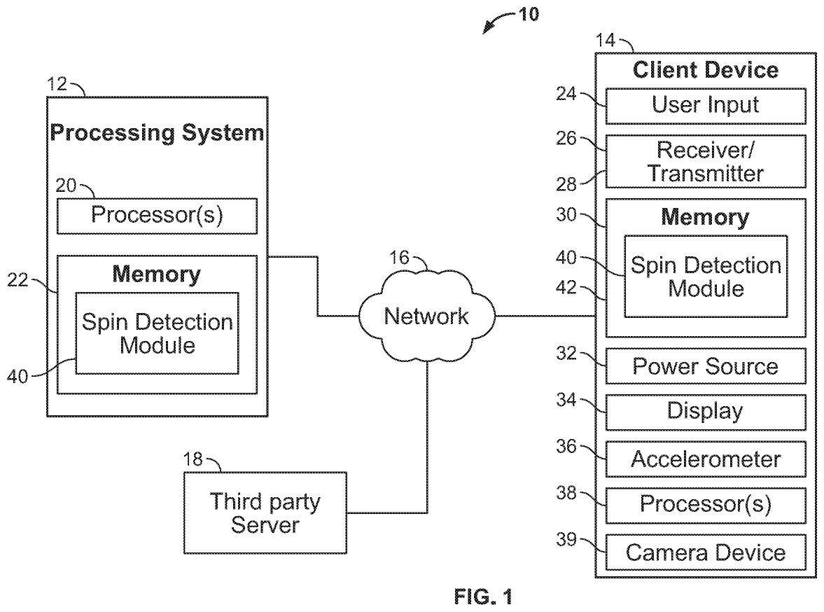

FIG. 1 is a block diagram of an example computing environment in which the techniques of this disclosure for altering media based on rotation of a client device can be implemented in accordance with various embodiments of the present disclosure;

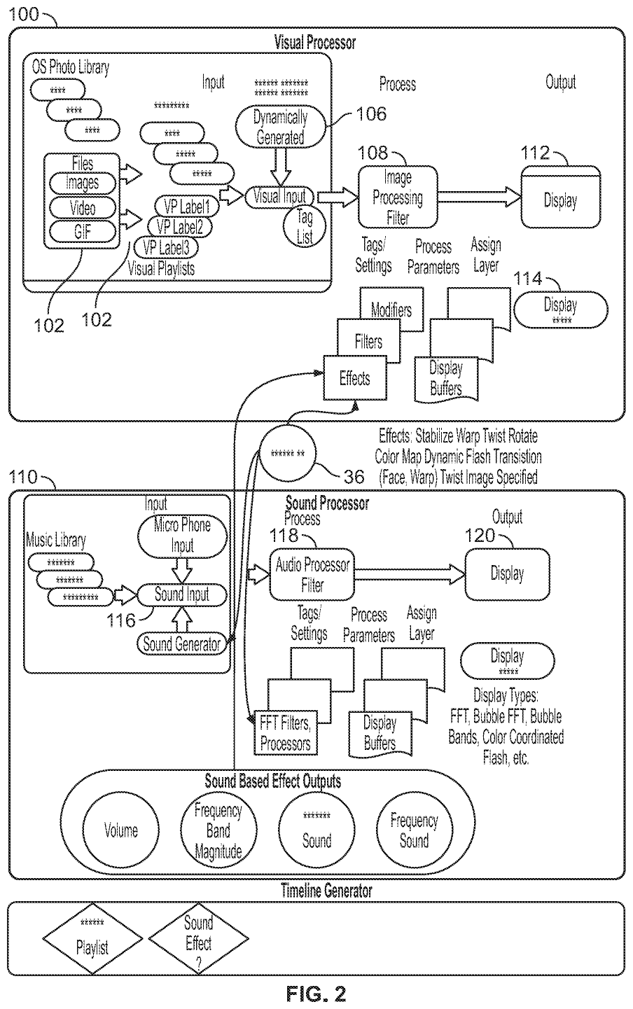

FIG. 2 is a flow chart showing interacting components and steps for altering media in accordance with various embodiments of the present disclosure;

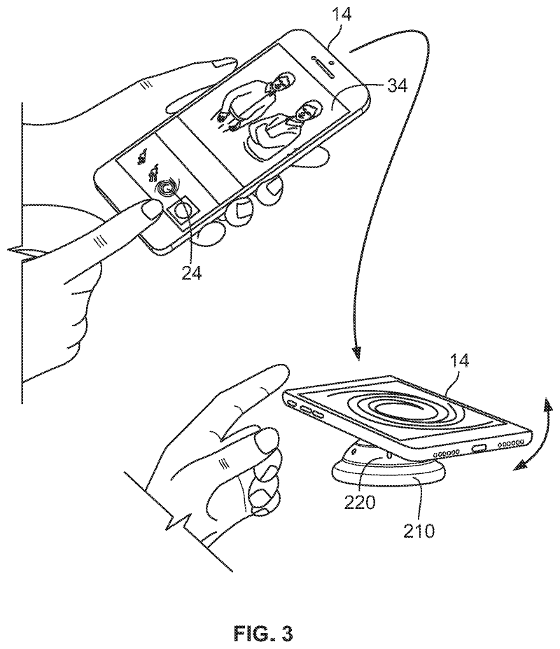

FIG. 3 schematically illustrates a client device with an example display and subsequent rotation in accordance with various embodiments of the present disclosure; and

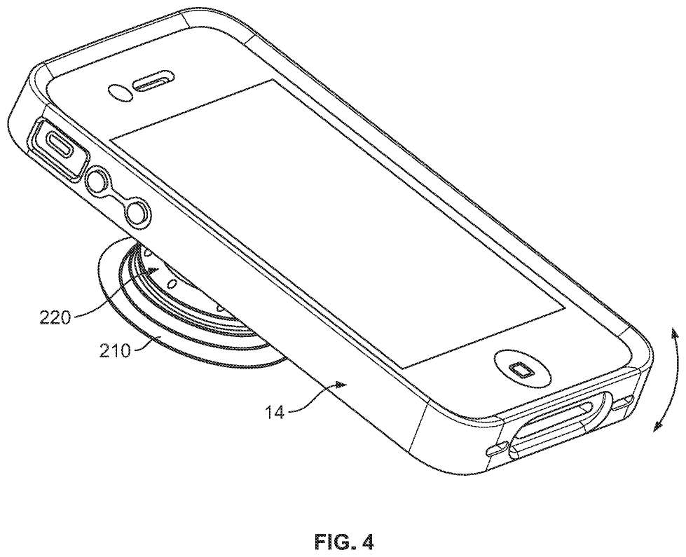

FIG. 4 schematically illustrates a client device affixed with an expandable/collapsible grip accessory in accordance with various embodiments of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Portable computing devices, software operating on such devices, and methods are described herein that utilize rotational data of the device to alter or distort media, such as images and/or video, operating on the device. More specifically, when operating the software, an accelerometer within the device can determine when a user rotates or spins the device and thereafter a processing device can alter the media. Rotational characteristics, such as spin direction, spin speed, spin rate of change, and the like, can further factor into the modifications to the media. The software described herein is particularly suitable for being implemented on a portable computing device affixed with a rotating accessory to enable users to easily rotate the portable computing device for media modification.

FIG. 1 illustrates one exemplary computing environment 10 in which techniques for altering or modifying media based on rotation of a client device may be implemented. In the computing environment 10, a processing system 12 can communicate with various client devices (e.g., client device 14), application servers, web servers, and other devices via a communication network 16, which can be any suitable network, such as the Internet, WiFi, radio, Bluetooth, NFC, etc. The processing system 12 includes one or more servers or other suitable computing devices. The communication network 16 can be a wide-area network (WAN) or a local-area network (LAN), for example, and can include wired and/or wireless communication links. A third-party server 18 can be any suitable computing device that provides web content, applications, storage, etc. to various client devices 14. The content can include media, such as images and/or video, in any suitable file format.

As illustrated in FIG. 1, the processing system 12 can include one or more processing devices 20 and a memory 22. The memory 22 can include persistent and non-persistent components in any suitable configuration. If desired, these components can be distributed among multiple network nodes. The client device 14 can be any suitable portable computing device, such as a mobile phone, tablet, E-reader, and so forth. The client device 14 can be configured as commonly understood to include a user input 24, such as a touch screen, keypad, switch device, voice command software, or the like, a receiver 26, a transmitter 28, a memory 30, a power source 32, which can be replaceable or rechargeable as desired, a display 34, an accelerometer 36, a processing device 38 controlling the operation thereof, and a camera device 39. The accelerometer 36 may be configured to periodically measure rotational characteristics of the device 14, which can include, general rotation, angular velocity, rate of change, direction, and so forth, of the client device 14 and/or determine orientation of the device 14 in a three-dimensional space. The memory 30 can include persistent and non-persistent components. As commonly understood, the components of the device 14 are connected by electrical pathways, such as wires, traces, circuit boards, and the like.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein

The client device 14 includes a spin detection module 40 stored in the memory 30 as a set of instructions executable by the processing device 38. The spin detection module 40 is configured to analyze measurements from the accelerometer 36 to identify rotational characteristics of the client device 14 and identify any triggering events. If desired, the functionality of the spin detection module 40 also can be implemented as a spin detection module application programming interface (API) 42 stored in the memory 30 that can include any content that may be suitable for the techniques of the current disclosure, which various applications executing on servers and/or client devices can invoke. For example, the API 42 may perform a corresponding action to modify or alter media on the client device in response to a rotation event of the client device detected by the spin detection module 40. The spin detection module 40, as set forth below, can invoke the API 42 when necessary, without having to send data to the processing system 12.

By another approach, the memory 22 of the processing system 12 stores instructions that implement a spin detection module 40 configured to receive and transmit data corresponding rotation events and actions measured by the accelerometer 36 of the client device 14 and third party servers 18. The spin detection module 40 may be implemented on the processing system 12, the client device 14 as discussed above, or in any suitable combination for setting and/or implementing the one or more media manipulation actions triggered by a rotation event.

The processing system 12 may receive spin data or measurements from the client device 14 corresponding to the various triggered actions from the client device 14. For example, the third-party server 18 can provide media to be displayed or played on the client device 14 and manipulated using the spin detection module 40 and request that the processing system 12 process rotation data received from the client device 14. As another example, the client device 14 can select one or more manipulation actions to be performed in response to a rotation event from a preset list provided by the processing system 12.

The media manipulation actions may include any action that the client device 14 is capable of performing. In an embodiment, a user of the system may be able to preconfigure one or more actions to be performed: when the device rotates, such as in a clockwise and/or counterclockwise direction, based on a speed of rotation, based on an acceleration or slowdown of rotation, and so forth.

The media being manipulated according to a given rotation event can be an image, gif, or video, whether stored locally or being provided by the third party server 18. The image, gif, or video can further be captured using the camera device 39 through the API 42 or selected from pre-saved images/videos.

An example flowchart showing interacting components of one example media alteration process is shown in FIG. 2. A visual processor 100 of the client device 14 begins with the selection 102 of a media file 104 that the user wants to alter or distort. As shown, the file can be selected from the OS photo library, captured with the camera device 39, for example. The user can then select 106 a desired distortion effect, the processor 100 can dynamically generate a distortion effect, or combinations thereof. With the combination of media file and distortion effect selected, the distortion process 108 is then ready to begin. The distortion process takes tags and settings into account, as well as process parameters that include any modifiers, filters, and/or effects selected or assigned for the distortion. The distortion process can be configured to begin in response to a rotation event measured by the accelerometer 36 and detected by the detection module 40.

If desired, the process can further utilize a sound processor 110 of the client device 14. More specifically, a user can select whether to alter sound characteristics of the media file, if applicable, and/or provide an audio file for altering and playback with the distorted image/video/gif. For example, the process can distort or otherwise alter the volume, frequency band magnitude, beat, and/or frequency of the audio. Of course, if desired, a user can input an unaltered audio file to playback with distorted image/video/gif.

After the processor 100 distorts the media file according to the selected settings, tags, and parameters, the client device 14 can display 112 the distorted media file. If desired, the interface can include display options 114 for selection by the user, which can include inserting alphanumeric and/or graphical content, cropping, resizing, altering color/contrast characteristics, and so forth.

Turning back to the sound processor 110, as shown in FIG. 2, a user can select an audio file 116 to input, which can come from any desired source, such as a music/sound library, microphone, and/or sound generator. The audio file 116 can then be altered 118 according to a rotation event measured by the accelerometer 36 of the client device 14. The sound processor 110 can manipulate the audio file according to any tags, settings, or process parameters selected by the user. As discussed above, the process can distort or otherwise alter the volume, frequency band magnitude, beat, and/or frequency of the audio file. Finally, the sound processor 110 can output 120 the altered audio file through a speaker of the client device.

Rotation events detected by the module 40 can cause the API 42 to modify or alter the image, gif, or video by distorting according to a selected distortion effect. As shown in FIG. 3, in one example, the image, gif, or video can be distorted by twisting into a spiral. In other examples, the image, gif, or video can be distorted with a kaleidoscope effect, a pixilation effect, a warp effect, a twist effect, a rotate color map effect, a dynamic flash effect, a transition effect, such as fade, warp, twist, etc., and/or an image specific effect. Other distortion effects (aka, filter effects) are within the scope of the disclosure. The distortion can be achieved by the user twisting the device 14 and/or spinning the client device 14 one of clockwise or counterclockwise. If desired, the user can stop the distortion by stopping the rotation of the device 14 or selection of the user input 24. By another approach, the speed of the spin can be utilized to control an amount of the distortion, or any other characteristic of the distortion. By a further approach, the file can be saved as a video, of any suitable moving image file format, such as .avi, .flv, .wmv, .mp4, .mov, a .gif, or other suitable file formats, transitioning between the original version and the distorted version of the image.

It will be understood that the user may be enabled to select which rotation event corresponds to which distortion effect and may customize the parameters of the distortion. Such customizations may be entered directly into the client device using the user input 24, at a remote computing device in an account at the processing system 12 and/or third-party server 18, and combinations thereof. For example, the user can preset a desired amount of distortion, assign one effect to clockwise rotation and another effect to counterclockwise rotation, and so forth.

The API 42 can further allow the user to alter the image, gif, or video by inserting text, stickers, graphics, such as emoticons, and so forth, either prior to or after the distortion effect. Desired text or graphics can be entered using the user input 24.

Advantageously, the API 42 can further allow a user to save a modified version of the image, gif, or video file that includes the distortion effect(s) entered by the various rotation events performed by the user. The file can be saved locally in the client device 14 or remotely, such as in the processing system 12 or third-party server 18. By a further approach, the API 42 can include a sharing functionality for a user to share the modified version of the image, gif, or video file to remote locations, such as social media sites. This can be achieved through selection of an icon or button of the user input 24. If desired, the API 42 can encode the modified file that can be decoded using the application or similar software.

For many approaches, the functionalities described herein can be utilized by a user twisting the client device 14 in a hand, spinning the client device 14 on a surface, and so forth. To further enable a user to easily rotate, spin, and manipulate the rotation of the client device 14, the device 14 may be affixed with an expandable/collapsible grip accessory 210, as illustrated in FIGS. 2 and 3. FIG. 3 schematically illustrates a client device 14 affixed with a grip accessory 210. The grip accessory 210 of FIG. 3 may include a rotating portion 220, which can include bearings, low-friction couplings, etc., that allows the client device 14 to spin freely relative to the remainder of the grip accessory 210, when the grip accessory 210 is held in a user's hand or placed on a surface, for example. In some instances, the grip accessory 210 of the current disclosure may include, at least in part, an extending grip accessory for a portable media player or portable media player case as disclosed in U.S. Pat. No.: 8,560,031, or U.S. Publication No. 2018/0288204, entitled “Spinning Accessory for a Mobile Electronic Device,” the entire disclosures of which are incorporated herein by reference.

The application software described herein can be available for purchase and/or download from any website, online store, or vendor over the communication network 16. Alternatively, a user can download the application onto a personal computer and transfer the application to the client device 14. When operation is desired, the user runs the application on the client device 14 by a suitable selection through the user input 24.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A computer-implemented method for altering media based on a rotation event of a client device, the method comprising:
receiving an image, gif, or video;
receiving a selection of a distortion effect;
measuring rotation of the client device with an accelerometer of the client device;
applying the distortion effect to the image, gif, or video based on the rotation of the client device.

2. The computer-implemented method of claim 1, wherein applying the distortion effect comprises applying a spiral distortion effect to the image, gif, or video.

3. The computer-implemented method of claim 1, wherein applying the distortion effect comprises applying a kaleidoscope effect to the image, gif, or video.

4. The computer-implemented method of claim 1, wherein applying the distortion effect comprises applying a pixilation effect to the image, gif, or video.

5. The computer-implemented method of claim 1, further comprising saving a modified image, gif, or video that includes the distortion effect.

6. The computer-implemented method of claim 5, wherein the modified image, gif, or video transitions between the image, gif, or video and the image, gif, or video with the distortion effect.

7. The computer-implemented method of claim 5, further comprising encoding the modified image, gif, or video.

8. The computer-implemented method of claim 1, further comprising inserting alphanumeric content on the image, gif, or video.

9. The computer-implemented method of claim 8, wherein inserting the alphanumeric content on the image, gif, or video comprises inserting the alphanumeric content on the image, gif, or video after the distortion effect.

10. The computer-implemented method of claim 1, further comprising inserting graphical content on the image, gif, or video.

11. The computer-implemented method of claim 10, wherein inserting graphical content on the image, gif, or video comprises inserting the graphical content on the image, gif, or video after the distortion effect.

12. A portable computing device comprising:
an accelerometer configured to determine rotation of the portable computing device;
a processing device coupled to the accelerometer, the processing device configured to:
receive an image, gif, or video;
receive a selection of a distortion effect;
measure rotation of the client device with an accelerometer of the client device;
apply the distortion effect to the image, gif, or video based on the rotation of the client device.

13. The portable computing device of claim 12, wherein the processing device configured to apply the distortion effect comprises one or more of: applying a spiral distortion effect to the image, gif, or video, applying a kaleidoscope effect to the image, gif, or video, and applying a pixilation effect to the image, gif, or video.

14. The portable computing device of claim 12, wherein the processing device is further configured to save a modified image, gif, or video that includes the distortion effect.

15. The portable computing device of claim 14, wherein the modified image, gif, or video transitions between the image, gif, or video and the image, gif, or video with the distortion effect.

16. The portable computing device of claim 14, wherein the processing device configured to save the modified image, gif, or video comprises encoding the modified image, gif, or video.

17. The portable computing device of claim 12, further comprising inserting alphanumeric content or graphical content on the image, gif, or video.

18. The portable computing device of claim 12, further comprising an expandable/collapsible grip accessory affixed to a back portion of the portable computing device by a securing element, wherein the expandable/collapsible grip accessory includes a rotating portion that is capable of allowing the portable computing device to rotate around an axis while another portion of the expandable/collapsible grip accessory remains still.

19. The portable computing device of claim 18, wherein the expandable/collapsible grip accessory further comprises:
an cover forming a tapered shape connected to the securing element, the cover capable of extending outward generally along its axis from the portable media player and retracting back toward the portable computing device by collapsing generally along its axis; and
a foot disposed at the distal end of the cover.

20. The portable computing device of claim 18, wherein the cover of the grip accessory comprises rigid walls interspersed with flexural hinges.
